(19) United States
(12) Patent Application Publication
(10) Pub. No.: US 2024/0062093 A1
(43) Pub. Date: Feb. 22, 2024

(54) METHOD FOR CANCELLING A QUANTUM NOISE

(71) Applicant: BEIJING BAIDU NETCOM SCIENCE TECHNOLOGY CO., LTD., BEIJING (CN)

(72) Inventors: Xin WANG, BEIJING (CN); Chenghong ZHU, BEIJING (CN); Xuanqiang ZHAO, BEIJING (CN)

(21) Appl. No.: 18/447,242

(22) Filed: Aug. 9, 2023

(30) Foreign Application Priority Data
Aug. 9, 2022 (CN) 202210952347.0

(51) Int. Cl. G06N 10/70; G06N 10/20

(52) U.S. Cl. CPC G06N 10/70; G06N 10/20

(57) ABSTRACT

A method is provided that includes: determining auxiliary qubits and a quantum state ρ on which a preset quantum operation is to be performed; modeling quantum noise in the quantum operation to obtain a quantum noise channel corresponding to the quantum operation; initializing an encoding circuit to be trained, where the encoding circuit includes an adjustable parameter and is configured to act on the quantum state ρ and the auxiliary qubits; defining an expression of first mapping, where a result obtained after the first mapping, the quantum noise channel, and the encoding circuit are connected in series is close to an identity channel within a preset error tolerance range; adjusting a value of the adjustable parameter of the encoding circuit to determine the first mapping; and determining, based on the trained encoding circuit and the first mapping, an unbiased estimate of a quantum operation result obtained after canceling quantum noise.

### CROSS REFERENCE TO RELATED APPLICATIONS

The present application claims priority to Chinese Patent Application No. 202210952347.0 filed on Aug. 9, 2022, the contents of which is hereby incorporated by reference in its entirety for all purposes.

### TECHNICAL FIELD

The present disclosure relates to the field of quantum computers, in particular, to the field of quantum noise mitigation technologies, and specifically, to an encoding circuit training method, a quantum noise cancellation method and apparatus in a quantum operation, an electronic device, a computer-readable storage medium, and a computer program product.

### BACKGROUND ART

The quantum computer technology has developed rapidly in recent years, but in the foreseeable future, a noise problem of a quantum computer is inevitable: Heat dissipation in a qubit or random fluctuation in a lower-layer quantum physical process flips or randomizes a qubit state, which leads to failure of a computation process.

Current technical solutions for dealing with quantum noise mainly include the following two categories: a quantum error correction technology and a quantum error mitigation technology.

In the quantum error correction technology, each logical qubit is composed of many physical bits, and error correction is implemented through a redundant physical qubit resource. However, as a number of physical bits increases, there are more types of errors that may occur in a system. In addition, an operation of multi-qubit encoding requires non-local interaction between physical qubits, and therefore both quantum error correction and a quantum gate of logical bits are difficult in implementation experimentally. The quantum error mitigation solution does not require additional physical bits, but imposes requirements on an error type and error controllability of a quantum circuit, and therefore is difficult in implementation on recent quantum computers, and its method is not universal.

### SUMMARY OF THE INVENTION

The present disclosure provides a quantum noise cancellation method and apparatus in a quantum operation, an electronic device, a computer-readable storage medium, and a computer program product.

According to an aspect of the present disclosure, a method for cancelling a quantum noise is provided, including: determining m auxiliary qubits and a quantum state ρ of n qubits on which a preset quantum operation is to be performed, wherein n and m are both positive integers; modeling the quantum noise in the quantum operation to obtain a quantum noise channel corresponding to the quantum operation; initializing an encoding circuit, wherein the encoding circuit comprises an adjustable parameter and is configured to act on the quantum state ρ and the m auxiliary qubits; defining an expression of first mapping, wherein a result obtained after the first mapping is connected to the quantum noise channel and the encoding circuit in series is substantially equal to an identity channel within a preset error tolerance range; adjusting a value of the adjustable parameter of the encoding circuit to determine the first mapping; and determining, based on the encoding circuit and the determined first mapping, an unbiased estimate of a result of the quantum operation with the quantum noise cancelled.

According to another aspect of the present disclosure, an electronic device for cancelling a quantum noise is provided, wherein the electronic device including: a memory storing one or more programs configured to be executed by one or more processors, individually or collectively, the one or more programs including instructions for causing the electronic device to perform operations comprising: determining m auxiliary qubits and a quantum state ρ of n qubits on which a quantum operation is to be performed, wherein n and m are both positive integers; modeling the quantum noise in the quantum operation to obtain a quantum noise channel corresponding to the quantum operation; initializing an encoding circuit wherein the encoding circuit comprises an adjustable parameter and is configured to act on the quantum state ρ and the m auxiliary qubits; defining an expression of first mapping, wherein a result obtained after the first mapping is connected to the quantum noise channel and the encoding circuit in series is substantially equal to an identity channel within a preset error tolerance range; adjusting a value of the adjustable parameter of the encoding circuit to determine the first mapping; and determining, based on the encoding circuit and the determined first mapping, an unbiased estimate of a result of the quantum operation with the quantum noise cancelled.

According to another aspect of the present disclosure, a non-transitory computer-readable storage medium that stores one or more programs is provided, wherein the one or more programs comprising instructions that, when executed by one or more processors of a computing device, individually or collectively, cause the computing device to implement acts comprising: determining m auxiliary qubits and a quantum state ρ of n qubits on which a quantum operation is to be performed, wherein n and m are both positive integers; modeling the quantum noise in the quantum operation to obtain a quantum noise channel corresponding to the quantum operation; initializing an encoding circuit, wherein the encoding circuit comprises an adjustable parameter and is configured to act on the quantum state ρ and the m auxiliary qubits; defining an expression of first mapping, wherein a result obtained after the first mapping is connected to the quantum noise channel and the encoding circuit in series is substantially equal to an identity channel within a set error tolerance range; adjusting a value of the adjustable parameter of the encoding circuit to determine the first mapping; and determining, based on the encoding circuit and the determined first mapping, an unbiased estimate of a result of the quantum operation with the quantum noise cancelled.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings show embodiments as examples and form a part of the specification, and are used to explain example implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a flowchart of a quantum noise cancellation method in a quantum operation according to an embodiment of the present disclosure;

FIG. 2 is a schematic diagram of a circuit for encoding and decoding according to an embodiment of the present disclosure;

FIG. 3 is a flowchart of determining an unbiased estimate of a result obtained after canceling quantum noise according to an embodiment of the present disclosure;

FIG. 4 is a schematic diagram of comparison of sampling costs for different bit flipping probabilities according to an embodiment of the present disclosure;

FIG. 5 is a structural block diagram of a quantum noise cancellation apparatus in a quantum operation according to an embodiment of the present disclosure; and

FIG. 6 is a structural block diagram of an example electronic device that can be used to implement an embodiment of the present disclosure.

### DETAILED DESCRIPTION OF EMBODIMENTS

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing illustrative examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

The embodiments of the present disclosure will be described below in detail with reference to the accompanying drawings.

So far, various types of computers in application all have used classical physics as a theoretical basis for information processing, and have been referred to as conventional computers or classical computers. Binary data bits that are easiest to implement physically are used by a classical information system to store data or programs. Each binary data bit is represented by 0 or 1 and referred to as a bit, and is the smallest information unit. The classical computers themselves have the inevitable disadvantages as follows: 1. most basic limitation from energy consumption in a computation process, in which minimum energy required by a logic element or a storage unit should be several times more than kT to avoid malfunction under thermal fluctuations; 2. information entropy and heating energy consumption; and 3. when a computer chip has a very high routing density, according to the Heisenberg's uncertainty principle, less uncertain electron positions indicate more uncertain momentum. When electrons are no longer confined, a quantum interference effect occurs. Such an effect may even damage performance of the chip.

Quantum computers are physical devices that follow the properties and laws of quantum mechanics to perform high-speed mathematical and logical computation, and store and process quantum information. Any device that processes and computes quantum information and runs a quantum algorithm is a quantum computer. The quantum computers follow the unique quantum dynamics law (especially quantum interference) to implement a new mode of information processing. For parallel processing of computing problems, the quantum computers have an absolute advantage over classical computers in speed. A transformation of each superposition component performed by the quantum computer is equivalent to a classical computation. All these classical computations are completed simultaneously and superposed based on a specific probability amplitude, and an output result of the quantum computer is provided. Such computing is referred to as quantum parallel computing. Quantum parallel processing greatly improves efficiency of the quantum computer, so that the quantum computer can complete operations that classical computers cannot complete, for example, factorization of a large natural number. Quantum coherence is essentially utilized in all ultrafast quantum algorithms. Therefore, quantum parallel computing with quantum states replacing classical states can achieve an incomparable computation speed and an incomparable information processing function than the classical computers and also save a large amount of computation resources.

With rapid development of the quantum computer technology, due to the powerful computing capability and fast running speed, an application range of a quantum computer becomes wider and wider. For example, chemical simulation is a process of mapping Hamiltonian of a real chemical system to physically operable Hamiltonian, and then modulating parameters and evolution time to find an eigenstate that may reflect the real chemical system. When an N-electron chemical system is simulated on a classical computer, solving of a 2^{N}-dimensional Schrodinger equation is involved, and a computation amount may increase exponentially with increase of the number of electrons in the system. Therefore, the role of the classical computer in chemical simulation is very limited, which can only be broken by means of a powerful computing capability of a quantum computer. The variational quantum eigensolver (Variational Quantum Eigensolver, VQE) algorithm is a variational quantum algorithm for chemical simulation on quantum hardware, and is currently one of the most promising applications of quantum computers and opens up many new fields of chemical research. However, currently, noise rates of quantum computers obviously limit the capability of the VQE, and therefore the quantum noise problem must be dealt with first.

A core computation process of the variational quantum eigensolver VQE algorithm is to estimate an expected value Tr[Oρ], where ρ is an output state generated by a quantum computer, an observable O is a physically operable Hamiltonian mapped from Hamiltonian of a real chemical system, and Tr represents taking a trace of a matrix (ρ, O are both represented mathematically by a matrix). In particular, only by ensuring that the estimation of Tr[Oρ] is accurate in thecomputation process, a precise and meaningful solution can be obtained, which in turn has application values in scenarios such as quantum chemistry. However, due to the existence of quantum noise, an actual evolution process of a quantum computer is described by a noise channel [symbol] , resulting in an actual expected value of Tr[O [symbol] (ρ)]. This leads to an error in the calculation result. Therefore, how to reduce or even cancel the impact of the noise channel [symbol] on expected value estimation to obtain an approximate estimate of Tr[Oρ] has become an urgent problem to be solved.

Quantum error correction is a technology that encodes a quantum state into a larger space through an auxiliary system and corrects errors in the computation process based on redundant information. With the help of quantum error correction, qubits affected by noise can be decoded and restored, reducing the impact of noise on a quantum computing result, so that quantum information can be transmitted and stored with greater fidelity. However, for current quantum devices, a number of qubits required for quantum error correction is excessively large, and even the current largest quantum computers are still far from a number of qubits required to achieve fault-tolerant quantum computing.

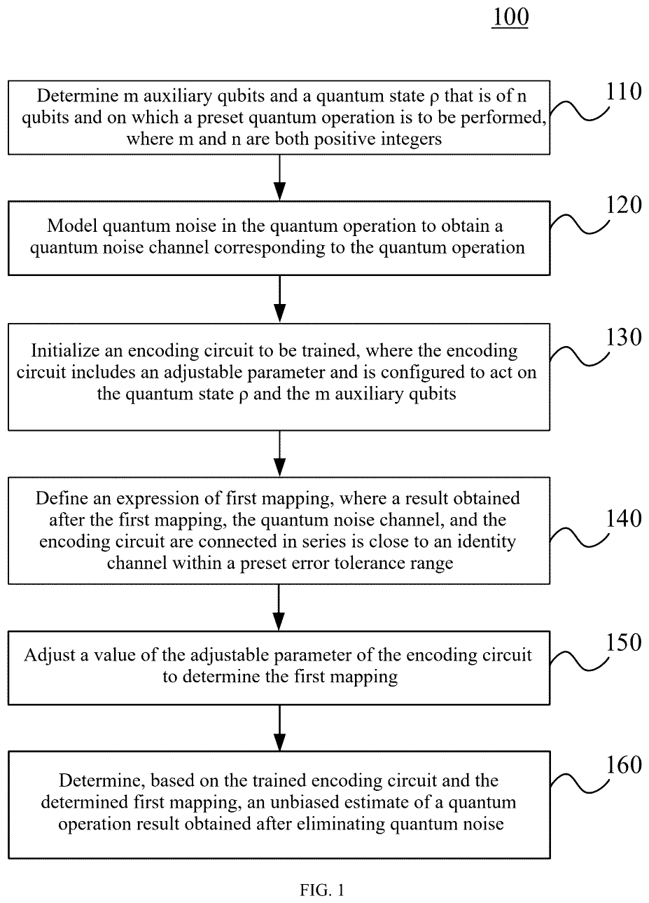

According to an aspect of the present disclosure, an example embodiment of the present disclosure provides a quantum noise cancellation method 100 in a quantum operation. As shown in FIG. 1, the method 100 includes: determining m auxiliary qubits and a quantum state ρ that is of n qubits and on which a preset quantum operation is to be performed, where n and m are both positive integers (step 110); modeling quantum noise in the quantum operation to obtain a quantum noise channel corresponding to the quantum operation (step 120); initializing an encoding circuit to be trained, where the encoding circuit includes an adjustable parameter and is configured to act on the quantum state ρ and the m auxiliary qubits (step 130); defining an expression of first mapping, where a result obtained after the first mapping, the quantum noise channel, and the encoding circuit are connected in series is close to an identity channel within a preset error tolerance range (step 140); adjusting a value of the adjustable parameter of the encoding circuit to determine the first mapping (step 150); and determining, based on the trained encoding circuit and the determined first mapping, an unbiased estimate of a quantum operation result obtained after canceling quantum noise (step 160).

According to the embodiment of the present disclosure, a small number of additional auxiliary qubits are introduced, a quantum state is encoded before being subject to noise, and then a corresponding decoder [symbol] is searched for for the encoded quantum state, so as to mitigate quantum noise.

In a quantum operation scenario, such as a quantum computing process or a quantum communication process using a quantum computer, a quantum state ρ to be measured becomes a noisy quantum state [symbol] (ρ) under the action of a quantum noise channel [symbol] . In a common quantum error mitigation framework (hereinafter referred to as “the previous method”), it is expected that mapping [symbol] = [symbol] ⁻¹ is applied to [symbol] (ρ), resulting in a zero-noise quantum state ρ= [symbol] ∘ [symbol] (ρ)= [symbol] ⁻¹∘ [symbol] (ρ)=ρ, where [symbol] ⁻¹ is the inverse mapping of the channel [symbol] . However, such mapping may not be an operation that may be physically implemented, for example, quasi-probabilistic decomposition may be performed on the mapping to obtain [symbol] =p₁ [symbol] ₁+p₂ [symbol] ₂, where p₁, p₂ is a real number satisfying p₁+p₂+1, and [symbol] ₁, [symbol] ₂ are two quantum channels that may be physically implemented. Then, Tr[O [symbol] ∘ [symbol] (ρ)] [symbol] Tr[Op] can be obtained by using the quasi-probabilistic sampling technology.

In the present disclosure, an encoding operation, including introduction of auxiliary qubits, is performed on the quantum state before the quantum state is subject to noise. Then, a corresponding decoding circuit [symbol] is searched for for a quantum state obtained after the encoded quantum state is subject to noise, that is, the first mapping, so that the entire process from encoding to subjecting to noise and then to first mapping is equivalent to an identity channel (identity channel, id). The trained encoding circuit and the determined first mapping can be used for quantum noise mitigation of a corresponding quantum operation.

In the method of the present disclosure, a larger Hilbert space (that is, a space where the quantum state is located) is used by means of auxiliary bits. Even if the introduced auxiliary bits are also affected by noise, the costs of quantum processing can be reduced by quantum phenomena such as entanglement.

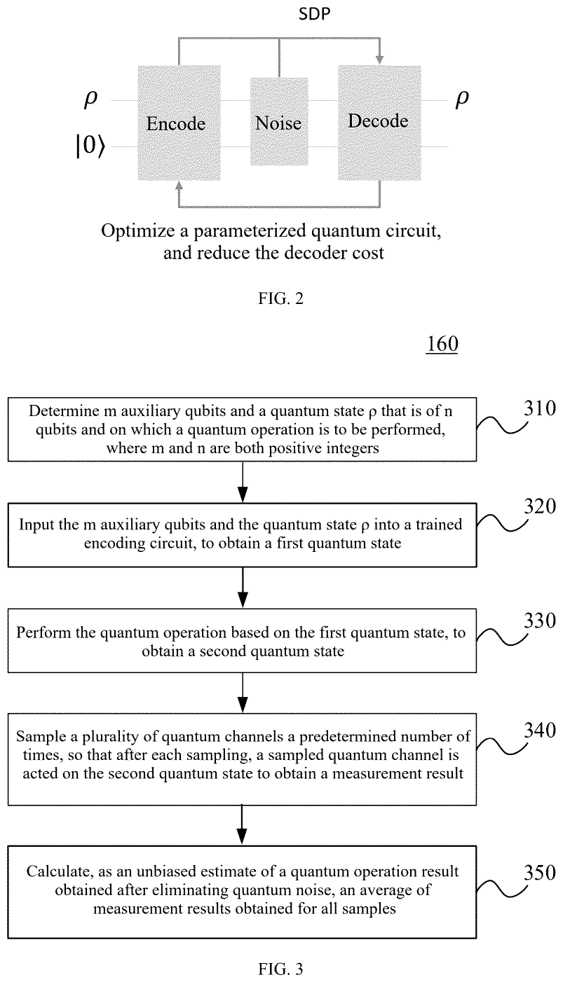

FIG. 2 is a schematic diagram of a circuit for encoding and decoding according to an embodiment of the present disclosure. As shown in FIG. 2, an encoding circuit is configured to encode a quantum state ρ that is not subject to noise and an auxiliary qubit. The figure shows a form of a single-bit quantum state ρ and one auxiliary qubit, and an encoded quantum state corresponds to two qubits. However, it can be understood that a multi-bit quantum state ρ and any number of auxiliary qubits are also applicable, and an appropriate number of auxiliary qubits can be selected according to a type of noise. A larger number of auxiliary qubits indicates the better effect of noise cancellation, but the larger calculation amount. The encoded quantum state is affected by the quantum noise corresponding to the quantum operation, and thus becomes a noisy quantum state. Finally, an expected value of the observable for the unencoded quantum state is estimated by applying the decoding circuit [symbol] to the noisy encoded quantum state.

Referring to FIG. 2, first, the quantum noise is modeled. According to some embodiments, the modeling quantum noise in the preset quantum operation includes: modeling the quantum noise by using a quantum tomography method, to obtain the quantum noise channel corresponding to the quantum operation. The quantum tomography method includes at least one selected from a group consisting of the following: a quantum process tomography (Quantum Process Tomography) method and a quantum gate set tomography (Quantum Process Tomography) method.

According to some embodiments, the encoding circuit may be a trainable model or an encoding operation optimized based on a machine learning method. Exemplarily, the encoding circuit includes any one of the following: a parameterized quantum circuit, a tensor network model, and a genetic algorithm model.

In some examples, a parameterized quantum circuit U(θ) consisting of several single-qubit rotation gates and CNOT gates (controlled NOT gates) can be used as the encoding circuit, and the circuit acts on a system composed of an input quantum system and m auxiliary bits in a |0 [symbol] state, where θ is a parameter of the circuit. The process of adding auxiliary bits and acting the encoding circuit (that is, the encoding process) is denoted as a quantum channel [symbol] .

In some examples, a result obtained after the encoding circuit, the quantum noise channel, and the first mapping are connected in series can be close to an identity channel within a preset error range. The preset error range can be set according to actual needs, such as 5% and 0. Assuming that the acceptable error tolerance is 2ε, it is necessary to define that the first mapping [symbol] satisfies formula (1):

$$\frac{1}{2} {‖ id - 𝒟 ∘ 𝒩 ∘ 𝒱 ‖}_{⋄} \leq ε \qquad formula ( 1 )$$

where [symbol] represents the encoding circuit. Ideally, when the preset error range is 0, that is, ∥id− [symbol] ∘ [symbol] ∘ [symbol] ∥₅₆₆=0, a result obtained after the encoding circuit, the quantum noise channel, and the first mapping are connected in series can be equal to an identity channel within a preset error range.

In the present disclosure, the first mapping may be set as one quantum channel, or quasi-probabilistic decomposition may be performed on the first mapping to obtain at least two quantum channels, that is, the first mapping may correspond to at least one quantum channel. The at least one quantum channel is in one-to-one correspondence with a corresponding decomposition coefficient.

Therefore, according to some embodiments, the adjusting a value of the adjustable parameter of the encoding circuit to determine the first mapping includes: performing quasi-probabilistic decomposition on the first mapping based on the expression, so that a sum of absolute values of decomposition coefficients obtained by the decomposition has a minimum value for a current value of the adjustable parameter, where the decomposition coefficients respectively correspond to a plurality of quantum channels obtained through decomposition; and adjusting the value of the adjustable parameter of the encoding circuit, so that the sum of the absolute values of the decomposition coefficients obtained by the decomposition has a minimum value.

As mentioned above, the first mapping may not be an operation that may be physically implemented, and therefore quasi-probabilistic decomposition may be performed on the first mapping to obtain a plurality of quantum channels. According to some embodiments, the quasi-probabilistic decomposition is performed according to formula (2):

[symbol]

=p₁ [symbol] ₁+. . . +pᵢ [symbol] ᵢ+. . . formula (2)

where D is the first mapping, [symbol] ᵢ is an i^{th} quantum channel obtained through decomposition, pᵢ is a decomposition coefficient corresponding to the i^{th} quantum channel, p₁+. . . +pᵢ+. . . =1, and |p₁|+. . . +|pᵢ|+. . . has a minimum value. For example [symbol] =p₁ [symbol] ₁+p₂ [symbol] ₂, where p₁, p₂ is a real number satisfying p₁+p₂=1, and [symbol] ₁, [symbol] ₂ are two quantum channels that may be physically implemented.

According to some embodiments, the quasi-probabilistic decomposition of the first mapping is based on a semi-definite programming (SDP) method. The semi-definite programming has an efficient classical algorithm, and therefore the quasi-probabilistic decomposition can be efficiently completed on a classical computer. However, it should be understood that other suitable methods for quasi-probabilistic decomposition are also possible, and the present disclosure is not limited thereto.

In a process of quasi-probabilistic sampling based on the result of quasi-probabilistic decomposition, sampling costs depend on γ=p₁|+. . . +|pᵢ|+. . . , and the smaller value γ indicates the lower sampling costs. Different quasi-probabilistic decomposition has different sampling costs. The decomposition is continuously optimized to control the error within the preset error range and at the same time satisfy that the value of γ is minimum.

According to the embodiment of the present disclosure, by introducing a small number of auxiliary qubits, quantum noise mitigation can be implemented at lower sampling costs.

Specifically, in the embodiment of performing quasi-probabilistic decomposition on the first mapping [symbol] to obtain two quantum channels according to the method of the present disclosure, a specified decomposition condition can be:

minimize γ=|p₁|+|p₂|

satisfy: [symbol] ∘ [symbol] ∘ [symbol] =id

[symbol]

=p₁ [symbol] ₁+p₂ [symbol] ₂

p₁≥0, p₂≤0, p₁+p₂=1

[symbol]

= [symbol] ∘ [symbol] ∘ [symbol] is denoted, and the semi-definite programming corresponding to the above decomposition condition is:

minimize γ=|p₁|+|p₂|

satisfy:

[symbol]

=J_{id}

[symbol]

=J [symbol] _{₁}+J [symbol] _{₂}

p₁+p₂=1

Tr_{B}(J [symbol] _{₁})=p₁I_{A}, Tr_{B}(J [symbol] _{₂})=p₂I_{A}

J [symbol] _{₁} [symbol] 0, J [symbol] _{₂}≤0

[symbol]

J_{id} [symbol] J [symbol] are Choi matrix expressions of [symbol] , [symbol] respectively, J [symbol] _{₁}, J₃₆ _{₂} are Choi matrix expressions of p₁ [symbol] ₁, p₂ [symbol] ₂ respectively, and I_{A} is an identity matrix. Therefore, the above decomposition can be efficiently performed on a classical computer to find J [symbol] , J [symbol] _{₁}, J [symbol] _{₂}, and thus the corresponding decomposition [symbol] =p₁ [symbol] ₁+p₂ [symbol] ₂ is obtained such that the sampling costs γ are minimized.

Further, γ=|p₁|+|p₂| obtained through decomposition can be denoted as a loss function, and the parameter θ of the encoding circuit can be adjusted by using optimization methods such as Powell, the above quasi-probabilistic decomposition process is repeated to minimize the loss function γ, and the obtained optimal parameter is denoted as Γ*, and the corresponding decoder (that is, the first mapping) is denoted as [symbol] *=p*₁ [symbol] *₁+p*₂ [symbol] *₂.

It can be understood that this is also applicable when the quasi-probabilistic decomposition is performed on the first mapping to obtain more than two quantum channels. Details are not provided herein again.

After the form of the first mapping and the trained encoding circuit are determined, noise mitigation can be performed on the corresponding quantum operation process based on the encoding circuit and the specific form of the first mapping, so as to conveniently cancel the interference of quantum noise.

According to some embodiments, as shown in FIG. 3, the determining, based on the trained encoding circuit and the determined first mapping, an unbiased estimate of a quantum operation result obtained after canceling quantum noise (step 160) includes: determining the m auxiliary qubits and the quantum state ρ that is of the n qubits and on which the quantum operation is to be performed, where n and m are both positive integers (step 310); inputting the m auxiliary qubits and the quantum state ρ into the trained encoding circuit, to obtain a first quantum state (step 320); performing the quantum operation based on the first quantum state, to obtain a second quantumstate (step 330); sampling the plurality of quantum channels for a predetermined number of times, so that after each sampling, a sampled quantum channel is acted on the second quantum state to obtain a measurement result (step 340); and calculating, as the unbiased estimate of the quantum operation result obtained after canceling the quantum noise, an average of measurement results obtained for all samples (step 350).

According to some embodiments, the predetermined number of times is determined according to formula (3):

K=2γ²ln(2/δ)/ε₁² formula (3)

1−δ is a preset confidence level, that is, 1−δ is a lower probability limit within a required error precision range (for example, calculation precision of the quantum computer after quantum noise is canceled). ε₁ is a preset sampling error, and γ=|p₁|+. . . |pᵢ|+. . .

The following description uses an example of the embodiment of performing quasi-probabilistic decomposition on the first mapping D to obtain two quantum channels. As mentioned above, the trained encoding circuit U(θ*) is acted on m auxiliary bits in a |0 [symbol] state and the input quantum state ρ on which the quantum operation is to be performed, and the obtained quantum state is denoted as: ρ_{enc}=U(θ*)(ρ⊗|0 [symbol] [symbol] 0|^{⊗m})(U† (θ*). The quantum operation is performed based on the quantum state ρ_{enc} to obtain the quantum state ρ_{noisy}= [symbol] (ρ_{enc}) affected by the quantum noise (corresponding to the quantum noise channel [symbol] ).

In the embodiment, the decomposition result based on the quasi-probabilistic decomposition is: [symbol] *=p*₁ [symbol] *₁+p*₂ [symbol] *₂, the probability distribution of the quantum channel is determined:

$$\{ ( \frac{\vert {p}_{1}^{*} \vert}{{γ}^{*}} , {𝒟}_{1}^{*} ) , ( \frac{\vert {p}_{2}^{*} \vert}{{γ}^{*}} , {𝒟}_{2}^{*} ) \} ,$$

according to formula (3), the preset number of sampling times is K, and in this case:

K=2γ^{*2}ln(2/δ)ε₁²

Therefore, the following two steps are iterated for a total of K rounds:

(1) In a K^{th} round (k∈{1,2. . . K}), quasi-probabilistic sampling is performed on the quantum channels [symbol] *₁and [symbol] *₂ based on the probability distribution

$$\{ ( \frac{\vert {p}_{1}^{*} \vert}{{γ}^{*}} , {𝒟}_{1}^{*} ) , ( \frac{\vert {p}_{2}^{*} \vert}{{γ}^{*}} , {𝒟}_{2}^{*} ) \} ,$$

to obtain [symbol] ᵢ^{(k)} through sampling, and the decomposition coefficient corresponding to the sampled quantum channel [symbol] ᵢ^{(k)} is denoted as pᵢ^{(k) (I ∈{}1,2}).

(2) The noisy quantum state ρ_{noisy} is used as the input of the quantum channel [symbol] ᵢ^{(k)}, and the measurement result Tr[ODᵢ^{(k)}(ρ_{noisy})] is obtained after the evolution of the quantum channel [symbol] ᵢ^{(k)}.

It can be understood that the quasi-probabilistic sampling process of more than two quantum channels obtaining by decomposing the first mapping is similar to the above process and will not be repeated herein.

After the measurement results obtained by all the sampling processes are obtained, an average can be obtained based on the calculation results, to determine an unbiased estimate of the quantum operation result obtained after canceling quantum noise.

According to some embodiments, the average of the obtained calculation results is calculated according to formula (4):

$$ξ = \frac{{γ}^{*}}{K} {Σ}_{k = 1}^{K} σ ( {p}_{i}^{( k )} ) Tr [ {OD}_{i}^{( k )} ( {ρ}_{noisy} ) ] \qquad formula ( 4 )$$

where σ(pᵢ^{(k)}) represents a positive sign or a negative sign of a decomposition coefficient pᵢ^{(k)} that corresponds to the i^{th} first quantum channel Dᵢ^{(k)} and that is obtained after k^{th} sampling, Tr[ODᵢ^{(k)}(ρ_{noisy})] represents a measurement result obtained after the k^{th} sampling, O is a qubit observable, ρ_{noisy} represents the second quantum state, i ∈{1,2, . . .}, and k ∈{1,2, . . . , K}.

Based on the Hoeffding inequality, the method according to the present disclosure can theoretically guarantee that the average ξ calculated according to formula (11) can be used to obtain an unbiased estimate average Tr[Oρ] at a probability greater than 1−δ, and the estimated error is within the range of 2ε+ε₁, where 2ε is the preset error range during quasi-probabilistic decomposition, and ε1 is the preset sampling error. Finally, the average ξ is output as a valid estimate of Tr[Oρ] after noise cancellation.

In the present disclosure, a plurality of types of quantum noise can be modeled simultaneously, or a plurality of types of quantum noise models can be input by a user, and an error processing solution simultaneously applicable to a plurality of types of noise can be obtained through optimization. For example, for S noise models [symbol] ₁, [symbol] ₂, . . . [symbol] ₛ, a first mapping that satisfies formula (1) may be defined in training optimization for each noise model [symbol] ₛ.

An example application is described below to demonstrate the advantages of the sampling costs of the method according to the embodiment of the present disclosure. In this application, the quasi-probabilistic decomposition is performed on the first mapping to obtain a plurality of quantum channels, bit flip noise [symbol] _{α} (bit flip) is used, and its Kraus operator is:

$${K}_{1} = [ \begin{matrix}\sqrt{1 - α} & 0 \\ 0 & \sqrt{1 - α}\end{matrix} ] \\ {K}_{2} = [ \begin{matrix}0 & \sqrt{α} \\ \sqrt{α} & 0\end{matrix} ]$$

where α is a bit flip probability. A quantum state ρ becomes [symbol] _{α}(π)=K₀πK₀^{†}+K₁πK₁^{†}through a noise channel. Herein, it is assumed that the bit flip probability is α=0.1.

Assuming that one qubit is affected by the noise, when no auxiliary bit is introduced, quasi-probabilistic sampling is directly performed to mitigate errors. In this case, the sampling cost γ₁ is 1.2500. When two auxiliary bits are introduced, the encoding operation needs to be performed on three qubits. Based on the method of the embodiment of the present disclosure, the optimal encoding circuit and the corresponding decoder [symbol] * are obtained through iterative training. Encoding is performed by using the optimized encoding circuit, and when the three qubits of the encoded quantum state are respectively subject to the noise channel, a noisy quantum state is obtained. In this case, the sampling cost γ₂ of the method according to the embodiment of the present disclosure is 1.0593, and is much smaller than that in the case without auxiliary bits.

To highlight the importance of the sampling cost, differences in numbers of sampling samples are compared. In the above two cases, required precision is the same, that is, it is assumed that δ=0.01 and ε₁=0.01. When no auxiliary qubit is introduced, the sampling cost is γ₁=1.2500, and the corresponding required number of sampling samples is

$$\frac{2 {γ}_{1}^{2} ( ln \frac{2}{δ} )}{{ε}^{2}} = 165572 .$$

When an auxiliary qubit is introduced, the sampling cost is γ₂=1.0593, and the number of sampling samples is

$$\frac{2 {γ}_{2}^{2} ( ln \frac{2}{δ} )}{{ε}^{2}} = 118907 .$$

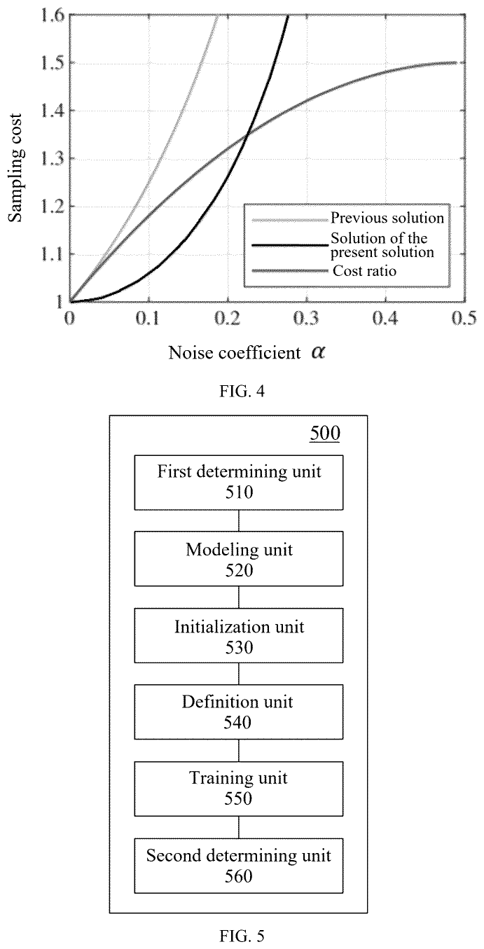

Finally, the sampling cost of the method according to the embodiment of the present disclosure is compared with that of the previous method at different bit flip probabilities, and the results are shown in FIG. 4. It can be seen from FIG. 4 that the method according to the embodiment of the present disclosure has a significant advantage in sampling costs, greatly reduces the required number of sampling samples, and is more practical.

According to another aspect of the present disclosure, an example embodiment of the present disclosure further provides a quantum noise cancellation apparatus 500 in a quantum operation. As shown in FIG. 5, the apparatus 500 includes: a first determining unit 510, configured to determine m auxiliary qubits and a quantum state ρ that is of n qubits and on which a preset quantum operation is to be performed, where n and m are both positive integers; a modeling unit 520, configured to model quantum noise in the quantum operation to obtain a quantum noise channel corresponding to the quantum operation; an initialization unit 530, configured to initialize an encoding circuit to be trained, where the encoding circuit includes an adjustable parameter and is configured to act on the quantum state ρ and the m auxiliary qubits; a definition unit 540, configured to define an expression of first mapping, where a result obtained after the first mapping, the quantum noise channel, and the encoding circuit are connected in series is close to an identity channel within a preset error tolerance range; a training unit 550, configured to adjust a value of the adjustable parameter of the encoding circuit to determine the first mapping; and a second determining unit 560, configured to determine, based on the trained encoding circuit and the determined first mapping, an unbiased estimate of a quantum operation result obtained after canceling quantum noise.

Herein, the operations of the foregoing units 510 to 560 of the quantum noise cancellation apparatus 500 in a quantum operation are respectively similar to the operations in steps 110 to 160 described above. Details are not provided herein again.

According to the embodiments of the present disclosure, there are further provided an electronic device, a readable storage medium, and a computer program product.

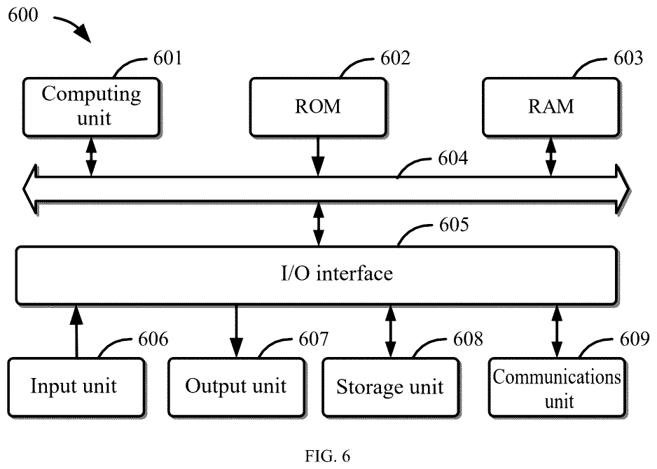

Referring to FIG. 6, a structural block diagram of an electronic device 600 that may serve as a server or a client of the present disclosure is now described, which is an example of a hardware device that may be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 6, the electronic device 600 includes a computing unit 601. The computing unit may perform various appropriate actions and processing according to a computer program stored in a read-only memory (ROM) 602 or a computer program loaded from a storage unit 608 to a random access memory (RAM) 603. The RAM 603 may further store various programs and data required for the operation of the electronic device 600. The computing unit 601, the ROM 602, and the RAM 603 are connected to each other through a bus 604. An input/output (I/O) interface 605 is also connected to the bus 604.

A plurality of components in the electronic device 600 are connected to the I/O interface 605, including: an input unit 606, an output unit 607, the storage unit 608, and a communications unit 609. The input unit 606 may be any category of device capable of entering information to the electronic device 600. The input unit 606 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 607 may be any category of device capable of presenting information, and may include, but is not limited to, a display, a speaker, a video/audio output terminal, a vibrator, and/or a printer. The storage unit 608 may include, but is not limited to, a magnetic disk and an optical disk. The communications unit 609 allows the electronic device 600 to exchange information/data with other devices via a computer network such as the Internet and/or various telecommunications networks, and may include, but is not limited to, a modem, a network interface card, an infrared communications device, a wireless communications transceiver, and/or a chipset, for example, a Bluetooth™ device, an 802.11 device, a WiFi device, a WiMax device, and/or a cellular communications device.

The computing unit 601 may be various general-purpose and/or special-purpose processing components with processing and computing capabilities. Some examples of the computing unit 601 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 601 performs the various methods and processing described above, for example, the method 100. For example, in some embodiments, the method 100 may be implemented as a computer software program, which is tangibly contained in a machine-readable medium, such as the storage unit 608. In some embodiments, a part or all of the computer program may be loaded and/or installed onto the electronic device 600 via the ROM 602 and/or the communications unit 609. When the computer program is loaded onto the RAM 603 and executed by the computing unit 601, one or more steps of the method 100 described above may be performed. Alternatively, in other embodiments, the computing unit 601 may be configured in any other suitable manner (for example, by means of firmware), to perform the method 100.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), the Internet, and a blockchain network.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

In the description herein, a predetermined or preset value, parameter, or threshold do not necessarily mean that the respective value, parameter, or threshold is fixed or is input, determined or set by a user. A predetermined or preset value, parameter, or threshold may be determined or set by a computing machine dynamically and automatically in the operation of the example implementations herein. Further, a predetermined or preset value, parameter, or threshold may be determined, set, adjusted, and/or trained through machine learning or artificial intelligence in the operations of the example implementations herein and/or based on the operation results of the example implementations herein.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely example embodiments or examples, and the scope of the present disclosure is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A computer-implemented method, the method comprising:
determining m auxiliary qubits and a quantum state ρ of n qubits on which a preset quantum operation is to be performed, wherein n and m are both positive integers;
modeling a quantum noise in the quantum operation to obtain a quantum noise channel corresponding to the quantum operation;
initializing an encoding circuit, wherein the encoding circuit comprises an adjustable parameter and is configured to act on the quantum state ρ and the m auxiliary qubits;
defining an expression of first mapping, wherein a result obtained after the first mapping is connected to the quantum noise channel and the encoding circuit in series is substantially equal to an identity channel within a set error tolerance range;
adjusting a value of the adjustable parameter of the encoding circuit to determine the first mapping; and
determining, based on the encoding circuit and the determined first mapping, an unbiased estimate of a result of the quantum operation with the quantum noise cancelled.

2. The method according to claim 1, wherein the adjusting the value of the adjustable parameter of the encoding circuit to determine the first mapping comprises:
performing quasi-probabilistic decomposition on the first mapping based on the expression, wherein a sum of absolute values of decomposition coefficients obtained by the decomposition has a minimum value for a current value of the adjustable parameter, wherein the decomposition coefficients respectively correspond to a plurality of quantum channels obtained through the decomposition; and
adjusting the value of the adjustable parameter of the encoding circuit, wherein the sum of the absolute values of the decomposition coefficients obtained by the decomposition has a minimum value.

3. The method according to claim 2, wherein the determining, based on the encoding circuit and the determined first mapping, the unbiased estimate of the result of the quantum operation with the quantum noise cancelled comprises:
determining the m auxiliary qubits and the quantum state ρ that is of the n qubits and on which the quantum operation is to be performed, wherein n and m are both positive integers;
inputting the m auxiliary qubits and the quantum state ρ into the encoding circuit, to obtain a first quantum state;
performing the quantum operation based on the first quantum state, to obtain a second quantum state;
sampling the plurality of quantum channels for a determined number of times, wherein after each sampling, a sampled quantum channel is acted on the second quantum state to obtain a measurement result; and
calculating, as the unbiased estimate of the result of the quantum operation with the quantum noise cancelled, an average of measurement results obtained for the determined number of times of samplings.

4. The method according to claim 1, wherein the encoding circuit comprises one or more of the following: a parameterized quantum circuit, a tensor network model, and a genetic algorithm model.

5. The method according to claim 1, wherein the modeling quantum noise in the quantum operation comprises: modeling the quantum noise by using a quantum tomography operation, to obtain the quantum noise channel corresponding to the quantum operation; and
wherein the quantum tomography operation comprises at least one of: a quantum process tomography operation or a quantum gate set tomography operation.

6. The method according to claim 2, wherein the quasi-probabilistic decomposition of the first mapping is based on a semi-definite programming operation.

7. The method according to claim 3, wherein the quasi-probabilistic decomposition is performed according to a formula: [symbol]
=p₁ [symbol] ₁+. . . +pᵢ [symbol] ᵢ+. . . ,
wherein [symbol] is the first mapping, [symbol] ᵢ is an i^{th} quantum channel obtained through the decomposition, pᵢ, is a decomposition coefficient corresponding to the i^{th} quantum channel, p₁+. . . +pᵢ+. . . =1, and |p₁|+. . . +|pᵢ|+. . . has a minimum value.

8. The method according to claim 7, wherein the determined number of times is determined according to a formula:
K=2γln(2/δ)/ε₁²,
wherein 1−δ is a eset confidence level, ε₁ is a sampling error, and γ=|p₁|+. . . |pᵢ|+. . . . ,

9. The method according to claim 8, wherein the average of the measurement results is calculated according to an average formula:
$$ξ = \frac{γ}{K} {\sum }_{k = 1}^{K} σ ( {p}_{i}^{( k )} ) Tr [ {OD}_{i}^{( k )} ( {ρ}_{noisy} ) ]$$
wherein σ(pᵢ^{(k)}) represents a positive sign or a negative sign of a decomposition coefficient pᵢ^{(k)} that corresponds to the i^{th} first quantum channel Dᵢ^{(k)} and that is obtained after a k^{th} sampling, Tr[ODᵢ^{(k)}(ρ_{noisy})] represents a measurement result obtained after the k^{th} sampling, O is a qubit observable ρ_{noisy} represents the second quantum state, i ∈{1,2, . . . }, and k∈{1,2, . . . , K}.

10. An electronic device, the electronic device comprising:
a memory storing one or more programs configured to be executed by one or more processors, individually or collectively, the one or more programs including instructions for causing the electronic device to perform operations comprising:
determining m auxiliary qubits and a quantum state ρ of n qubits on which a preset quantum operation is to be performed, wherein n and m are both positive integers;
modeling a quantum noise in the quantum operation to obtain a quantum noise channel corresponding to the quantum operation;
initializing an encoding circuit, wherein the encoding circuit comprises an adjustable parameter and is configured to act on the quantum state ρ and the m auxiliary qubits;
defining an expression of first mapping, wherein a result obtained after the first mapping is connected to the quantum noise channel and the encoding circuit in series is substantially equal to an identity channel within a preset error tolerance range;
adjusting a value of the adjustable parameter of the encoding circuit to determine the first mapping; and
determining, based on the encoding circuit and the determined first mapping, an unbiased estimate of a result of the quantum operation with the quantum noise cancelled.

11. The electronic device according to claim 10, wherein the adjusting the value of the adjustable parameter of the encoding circuit to determine the first mapping comprises:
performing quasi-probabilistic decomposition on the first mapping based on the expression, wherein a sum of absolute values of decomposition coefficients obtained by the decomposition has a minimum value for a current value of the adjustable parameter, wherein the decomposition coefficients respectively correspond to a plurality of quantum channels obtained through the decomposition; and
adjusting the value of the adjustable parameter of the encoding circuit, wherein the sum of the absolute values of the decomposition coefficients obtained by the decomposition has a minimum value.

12. The electronic device according to claim 11, wherein the determining, based on the encoding circuit and the determined first mapping, the unbiased estimate of the result of the quantum operation with the quantum noise cancelled comprises:
determining the m auxiliary qubits and the quantum state ρ that is of the n qubits and on which the quantum operation is to be performed, wherein n and m are both positive integers;
inputting the m auxiliary qubits and the quantum state ρ into the encoding circuit, to obtain a first quantum state;
performing the quantum operation based on the first quantum state, to obtain a second quantum state;
sampling the plurality of quantum channels for a determined number of times, wherein after each sampling, a sampled quantum channel is acted on the second quantum state to obtain a measurement result; and
calculating, as the unbiased estimate of the result of the quantum operation with the quantum noise cancelled, an average of measurement results obtained for the determined number of times of samplings.

13. The electronic device according to claim 10, wherein the encoding circuit comprises one or more of: a parameterized quantum circuit, a tensor network model, or a genetic algorithm model.

14. The electronic device according to claim 10, wherein the modeling quantum noise in the quantum operation comprises: modeling the quantum noise by using a quantum tomography operation, to obtain the quantum noise channel corresponding to the quantum operation; and
wherein the quantum tomography operation comprises at least one of: a quantum process tomography operation or a quantum gate set tomography operation.

15. The electronic device according to claim 11, wherein the quasi-probabilistic decomposition of the first mapping is based on a semi-definite programming operation.

16. The electronic device according to claim 12, wherein the quasi-probabilistic decomposition is performed according to a formula: [symbol]
=pᵢ= [symbol] ₁+. . . +pᵢ [symbol] ᵢ+. . . ,
wherein [symbol] is the first mapping, [symbol] ᵢ is an i^{th} quantum channel obtained through the decomposition, pᵢ is a decomposition coefficient corresponding to the i^{th} quantum channel, p₁+. . . +pᵢ+. . . =1, and |p₁|+. . . +|pᵢ|+. . . has a minimum value.

17. The electronic device according to claim 16, wherein the predetermined number of times is determined according to a formula:
K=2γ²ln(2/δ)ε₁²,
wherein 1−δ is a preset confidence level, ε₁ is a preset sampling error, and y=|p₁|+. . . |pᵢ|+. . . .

18. The electronic device according to claim 17, wherein the average of the measurement results is calculated according to an average formula:
$$ξ = \frac{γ}{K} {\sum }_{k = 1}^{K} σ ( {p}_{i}^{( k )} ) Tr [ {OD}_{i}^{( k )} ( {ρ}_{noisy} ) ]$$
wherein σ(pᵢ^{(k)}) represents a positive sign or a negative sign of a decomposition coefficient pᵢ^{(k)} that corresponds to the i^{th} first quantum channel Dᵢ^{(k)} and that is obtained after a k^{th} sampling, Tr[ODᵢ^{(k)}(ρ_{noisy})] represents a measurement result obtained after the k^{th} sampling, O is a qubit observable ρ_{noisy} represents the second quantum state, i ∈{1,2, . . . }, and k ∈{1,2, . . . , K}.

19. A non-transitory computer-readable storage medium that stores one or more programs comprising instructions that, when executed by one or more processors of a computing device, individually or collectively, cause the computing device to implement acts comprising:
determining m auxiliary qubits and a quantum state ρ of n qubits on which a preset quantum operation is to be performed, wherein n and m are both positive integers;
modeling a quantum noise in the quantum operation to obtain a quantum noise channel corresponding to the quantum operation;
initializing an encoding circuit, wherein the encoding circuit comprises an adjustable parameter and is configured to act on the quantum state ρ and the m auxiliary qubits;
defining an expression of first mapping, wherein a result obtained after the first mapping is connected to the quantum noise channel and the encoding circuit in series is substantially equal to an identity channel within a set error tolerance range;
adjusting a value of the adjustable parameter of the encoding circuit to determine the first mapping; and
determining, based on the encoding circuit and the determined first mapping, an unbiased estimate of a result of the quantum operation with the quantum noise cancelled.

20. The non-transitory computer-readable storage medium according to claim 19, wherein the adjusting the value of the adjustable parameter of the encoding circuit to determine the first mapping comprises:
performing quasi-probabilistic decomposition on the first mapping based on the expression, wherein a sum of absolute values of decomposition coefficients obtained by the decomposition has a minimum value for a current value of the adjustable parameter, wherein the decomposition coefficients respectively correspond to a plurality of quantum channels obtained through the decomposition; and
adjusting the value of the adjustable parameter of the encoding circuit, wherein the sum of the absolute values of the decomposition coefficients obtained by the decomposition has a minimum value.
